(19) United States
(12) Patent Application Publication
(10) Pub. No.: US 2003/0200271 A1
(43) Pub. Date: Oct. 23, 2003

(54) Reply recognition in communication

(76) Inventor: Petr Hejl, White Rock (CA)

Correspondence Address: Clifford W. Vermette, Vermette & Co., Box 40, Granville Square, 200 Granville Street, Suite 230, Vancouver, BC, V6C 1S4, CA

(21) Appl. No.: 10/418,068

(22) Filed: Apr. 18, 2003

(30) Foreign Application Priority Data
Apr. 22, 2002 (CA) 2,382,819

(51) Int. Cl. G06F 15/16

(52) U.S. Cl. 709/206; 709/205

(57) ABSTRACT

A communication method of sending and receiving messages via n communication lines. For each sending line there is corresponding receiving line with the same identification (e.g. mobile phone number). The first message to a receiver is sent via the first communication line, the second message to a receiver is sent via the second communication line, . . . the n-th message to this receiver is sent via the n-th communication line. When a reply from a receiver comes back via the i-th communication line, it is assigned to the i-th message sent. For each sent message the communication system remembers the sender, so that the reply can be delivered to this sender.

### FIELD

The present invention relates to a method of identifying reply messages in communications.

### BACKGROUND

Present Status

In communications, in which messages are sent and received, it is often necessary to assign the received messages to the original sent messages. For example, one may send the following question “How are you today?” and get the answer “Good.”. But if one sends many questions to many people at one time and receives answers from them, it is necessary to associate the questions and the answers to understand the answer.

Existing Solutions

The existing relationship between sent and received messages may currently be achieved in the following three ways:

1. Fixed Connection

There is a fixed connection between the sending and receiving point. For example, one's computer is firmly connected with the keyboard and with the display via cables.

2. Temporary Connection

A temporary connection is made between the sending and receiving point. For example, if one speaks to a person by telephone, a temporary connection between the sendor's telephone and the receiver's telephone is made and this connection is removed after the communication is finished.

3. Message Identification

Message identification is included into the sent message and the same or a modified identification is included into the received message. For example, if one sends an email, one writes a message for this email and, in addition, writes a subject reference in front of the text. The reference to the subject matter is returned to the original sendor in the reply, which usually starts with “Re:”.

Problem

The problem is what to do in the situations, when sent and received messages are to be associated with each other and it is not possible or desirable to use one of the solutions 1, 2, or 3 above. A typical example of the problem occurs in mobile phone SMS messaging. In SMS messaging it is not possible to make any connection between the sending and receiving mobile phones and it is also not technologically possible to add any information to the existing SMS message format.

### SUMMARY OF THE INVENTION

New Solution to be Patented

Messages are sent and received via different identified communication lines. For each sent message, the communication line over which the message was sent is also used for the reply, so that the reply can be assigned to the original message.

### BRIEF DESCRIPTION OF THE DRAWING

Further features and advantages will be apparent from the following detailed description, given by way of example, of a preferred embodiment taken in conjunction with the accompanying drawings, wherein:

FIG. 1 is a schematic diagram of a communication scheme with two sendors and recipient communicating through an intermediary X.

### DETAILED DESCRIPTION WITH REFERENCE TO THE DRAWING

Algorithm

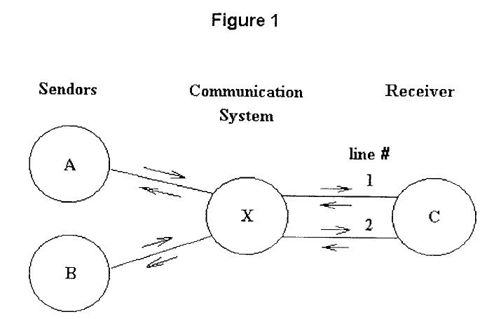

Referring to FIG. 1, a sender, A, sends a message to C through a communication system X, and the latter forwards the message to C via line 1. When C replies to this message, the communication system receives this reply on line 1. Because the reply was received on the same line as the original sent message, the communication system recognizes that the reply belongs to A. For a person B, who sends a message to C, the procedure is identical to that for A except that the communication between X and C is on line 2. This system can be conveyed algorithmically as follows:

Scheme (->means message transfer here): Sending person or computer->communication system->replying person or computer->communication system->sending person or computer.

Sending:

The communication system between X and the recipients has n communication lines available, via which messages may be sent and received. Each of these lines has its own identification. There is also an (n+1)th universal line .

The first message to a recipient person or computer is sent via the first line.

The second message to a recipient person or computer is sent via the second line.

The n-th message to a recipient person or computer is sent via the nth line.

Receiving:

When a reply from the replying person or computer comes back to the communication system via the first line, it is assigned to the first message sent.

When a reply from the replying person or computer comes back to the communication system via the second line, it is assigned to the second message sent.

When a reply from a replying person or computer comes back to the communication system via the nth line, it is assigned to the nth message sent.

Clearing:

When a reply comes from a replying person via the i^{th} communication line, all communication lines, via which earlier messages were sent to this replying person or computer (with some time reserve) other than the i^{th} line, may be released. The time reserve should be greater than maximum time difference between receiving two messages, sent at the same time.

Complements:

The following complements do not change the method of this invention, which is reply recognition by sending and receiving messages via n communication lines. However they describe and explain various situations in realizing this method.

Connection

Instead of mobile phones, connected to the communication system, also modems, SMS terminals or other communication devices can be used. For direct connection of the communication system to the operator various ways of communication can be used, e.g. modems, Internet (WWW, TCP/IP), fixed phone lines, etc.

Channel

The n communication lines can be also realized using one communication channel, connecting the communication system with the operator, e.g. with the mobile phone operator SMS center. In this case, the single lines are identified by mobile phone numbers, which are sent to the operator together with each message, in the sense “send this message to the receiver via this mobile phone number”.

Different Realization of Sending and Receiving Lines:

The sending lines can be realized differently from the receiving lines. For example, the sending lines can be realized by connecting the communication system directly to the mobile phone operator SMS center while the receiving lines can be realized by connecting n mobile phones to the communication system. The correspondence between the sending and receiving communication lines is reached by identical identification of corresponding lines, i.e. the i-th sending communication line has the same mobile phone number as the i-th receiving communication line. When sending from the communication system to the mobile phone operator SMS center, the corresponding i-th mobile phone number is sent together with the message and it is this mobile phone number via which the message is to be sent to the receiver. When receiving using connected mobile phones, the connected i-th mobile phone has the same mobile phone number as the sending i-th communication line, so that the reply to the message, which was sent via the i-th direct sending line, is received via the i-th connected mobile phone.

Random Choice

When for each receiver the first message would be sent via the first communication line, the second message via the second communication line, . . . , the n-th message via the n-th communication line, then the first communication line would be by far the most used of the communication lines, followed by the second communication line, and so on . . . . The n-th communication line would probably be used rarely. For the purpose of speeding up the sending process, a random selection of the communication lines can be used. For one receiver, the available communication lines are found. These are lines via which no message was yet sent, via which the reply was received, and which were cleared for sending. From these available communication lines one line is chosen at random. The message is sent via this line and sending via this line is remembered by the communication system.

Insufficient Number of Communication Lines

The number of communication lines is always limited, even in the case when a large number of communication lines is available. For example, for SMS messages, sent from one operator to another operator, each mobile phone number must have some physical destination (like a SIM card) for receiving, which limits the number of communication lines used for reply recognition. So the situation can occur, that all available n communication lines were already used, such as for example, if messages were sent on all these lines and no replies in response were sent. In this case none of these lines would be free for sending messages. This situation can be solved by seven methods, either individually or in combination. The first four of these methods have already been described in the text of the patent application. The last three methods are described here.

Communication Lines for Each Receiver

For each receiver a table of n communication lines can be created, in which the sender of each message is listed for each communication line used. In this table the identification (e.g. mobile phone number) of the first sender is written to the field of the first communication line, the identification of the second sender is written to the field of the second communication line, . . . , and the identification of the n-th sender is written to the field of the n-th communication line. So for each receiver all the communication lines can be available, which for the purpose of reply recognition multiplies the number of n communication lines by the number of receivers.

Clearing After Receiving Reply

When a reply is received to a message sent originally from a receiver via the i-th communication line (with some time reserve, greater than maximum time difference between receiving two messages), the i-th communication line can be made free for sending (to this receiver). Moreover, all the communication lines along which the messages to the same receiver were sent prior to the message can be made free for sending.

Waiting

When all the n communication lines were already used to send messages (to a receiver), then the communication system does not send the (n+1)th message m (to this receiver), but waits till at least one reply (from this receiver) arrives.

Universal (n+1)th Communication Line

When all the n communication lines have already used to send messages (to a receiver), then the universal (n+1)th communication line is used to send the (n+1)th message (to this receiver). Some formula such as “(start Reply with Rj)”, where j is some number, is included into the text of the message and the receiver must start the reply with this formula. The communication system remembers for each such sent messages the sender, the sending (n+1)th communication line and the formula. When the reply arrives, the communication system derives the sender from the facts, that the reply was received via the (n+1)th receiving communication line and that the text of the reply starts with the formula.

Large Number of Communication Lines

Large number of communication lines (also 1000 or even 1000000 etc.) can be available when the communication lines are realized by connecting the communication system directly to the operator. When a large number of communication lines are used separately for each receiver, then this makes the total available number of communication lines for reply recognition practically inexhaustible.

Clearing Old Messages

All communication lines via which the messages were sent some time ago, e.g. three days ago can be cleared. Alternatively, these communication lines need not be cleared. They can still wait for replies, however, they are also marked as being available for sending, i.e. they can be used for sending when no really free lines are available.

Round Method

The round (cyclic) method for sending messages means, that for sending (to one receiver) consecutively the 1^{st}, 2^{nd}, . . . n-th communication line is used and after the nth communication line again the 1^{st} communication line is used.

Insufficient Number of Communication Lines:

When the number of messages sent to one replying person or computer exceeds n (the number of communication lines) and no lines were made free in the meantime, then either the communication system must wait for some time to send the messages to this person or computer (until at least one reply comes from this person or computer; or until the time period elapses, when replies to old messages are improbable), or the communication system must include into the text of the sent message a formula such as “(start reply with Rj)”, where j is the serial number of the message, sent to this person or computer without having any free communication lines. The message with the reply formula will be sent by an (n+1)th “universal” line.

Remarks:

Communication lines, for example, may be realised in the following two ways:

(1) by connecting n mobile phones to the communication system, with each of these phones having its mobile phone number

(2) by connecting the communication system to the mobile phone operator SMS center using n different lines, identified by mobile phone numbers.

The method makes pairs between sent messages and received replies, i.e., assigns replies to the original sent messages, i.e. returns replies to users, boxes and applications.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

I claim:

1. A method of sending messages and receiving and recognizing replies, comprising:
(a) sending messages via n sending communication lines, wherein each communication line has an identification;
(b) providing for each sending communication line a corresponding receiving communication line with the same identification;
(c) sending an ith message to an ith receiver via an ith of said n communication lines; and
(e) assigning a reply received from an ith receiver via an ith communication line to an ith one of said n messages sent where i takes on integer values of 1 to n in succession.
